(19) United States
(12) Patent Application Publication
(10) Pub. No.: US 2009/0252465 A1
(43) Pub. Date: Oct. 8, 2009

(54) WAVEGUIDE AND RESONATOR CAPABLE OF SUPPRESSING LOSS DUE TO SKIN EFFECT

(75) Inventors: Yoshihisa Iwashita, Uji-shi (JP); Yujiro Tajima, Kawasaki-shi (JP)

Correspondence Address: OLIFF & BERRIDGE, PLC, P.O. BOX 320850, ALEXANDRIA, VA, 22320-4850, US

(73) Assignee: KYOTO UNIVERSITY, Kyoto-shi (JP)

(21) Appl. No.: 12/375,329

(22) PCT Filed: Jun. 21, 2007
(86) PCT No.: PCT/JP2007/000668

§ 371 Date: Jan. 27, 2009

(30) Foreign Application Priority Data
Jul. 31, 2006 (JP) 2006-208789

(51) Int. Cl. G02B 6/44

(52) U.S. Cl. 385/101

(57) ABSTRACT

The objective of the present invention is to provide a waveguide and resonator capable of suppressing the energy loss due to the skin effect. A conductive material layer is formed in the vicinity of an inside tube in the region between an outside tube and the inside tube which share the central axis and are made of a conductive material. A spacer layer (space) is formed between the surface of the inside tube and the conductive material layer. In the spacer layer, the end is thicker than the center in the layered body of the spacer layer and the conductive material layer. With the provision of such a layered body, the energy loss due to the skin effect can be suppressed. The effect becomes more prominent with a larger difference of the thickness of the spacer layer between the center and the end.

### TECHNICAL FIELD

The present invention relates to a waveguide or resonator of electromagnetic waves used in many fields such as a wireless communication device, broadcast equipment, microwave/radiofrequency wave device, and particle accelerator. In particular, it relates to the technique for suppressing the energy loss due to the skin effect occurring in a waveguide or resonator of electromagnetic waves.

### BACKGROUND ART

Conventionally, an electromagnetic wave's waveguide and resonator used in a radio-frequency band such as a microwave band and millimeter waveband have had a disadvantage in that an energy loss occurs due to the skin effect. The skin effect is the phenomenon in which an alternating electric current concentrates only in the vicinity of the surface of a conductor, i.e. in the region from the surface to the skin thickness δ=(2/ωμσ)^{1/2}, where ω is the frequency of the alternating electric current, μ is the magnetic permeability of the electric conductor, and σ is the electric conductivity of the electric conductor. The electrical power P consumed (i.e. lost) by the skin effect is expressed as follows using the current distribution i in the conductor:

P=∫|i|²/σdV (1)

The expression (1) indicates two manners to suppress the consumption of the power P: (i) increasing the electric conductivity σ, and (ii) controlling the current distribution i. For the electric conductivity σ, practically silver (σ=6.30×10⁷ S/m) is the only conductive material having a higher electric conductivity than that of copper (σ=5.96×10⁷ S/m) which is used in many waveguides and resonators. However, even if silver is used, the consumption of the power P can be enhanced at most approximately 4%. Therefore, it is necessary to study the control of the current distribution i.

Patent Document 1 discloses the use of, in a dielectric resonator whose inside is filled with a dielectric material, a thin-film multilayer electrode in which a thin film conductors and thin film dielectrics are alternately stacked in order to suppress such an energy loss. It is disclosed that optimal setting of the thickness of each of the thin film conductors and thin film dielectrics can allow an electric current to be distributed to each thin film conductor in a balanced manner, which suppresses the skin effect.

Patent Document 2 discloses the technique that, in a similar dielectric resonator as in Patent Document 1, the area of each layer of the thin-film multilayer electrode is decreased in series from the outside of the resonator toward the inside thereof. It is explained that this substantially uniforms the actual electric current flowing in each conductive material layer, which minimizes the loss. One example of such a thin-film multilayer electrode will be explained with reference to FIG. 1. FIG. 1(a) is a longitudinal section view of a dielectric resonator 10 using the thin-film multilayer electrodes 11 and 12, and FIG. 1(b) is a top view of the thin-film multilayer electrode 11. The dielectric resonator 10 is composed of a cylindrical resonator dielectric 13, in which an electromagnetic wave will be existent, and the thin-film multilayer electrodes 11 and 12 provided at the opposite sides of the resonator dielectric 13, respectively. The thin-film multilayer electrode 11 is composed of the following three components: a disk-shaped electric conductor 111, an interlayer dielectric 112 having a central hole and placed on the electric conductor 111, and an electric conductor 113 placed on the interlayer dielectric 112. The interlayer dielectric 112 has the smaller outside diameter than that of the electric conductor 111, and the shape of the electric conductor 113 is the same as the interlayer dielectric 112. The thin-film multilayer electrode 12 has the same configuration as the thin-film multilayer electrode 11.

[Patent Document 1] International Publication Pamphlet No. 95/006336

[Patent Document 2] Japanese Unexamined Patent Application Publication No. 2004-120516

### DISCLOSURE OF THE INVENTION

### Problem to be Solved by the Invention

The inventors of the present invention have computed the change of the Q value of the dielectric resonator 10 in accordance with ∈ₐ/∈_{b}, which is the ratio of the permittivity ∈ₐ of the interlayer dielectrics 112 and 122 to the permittivity ∈_{b} of the resonator dielectric 13. The result is illustrated in the graph of FIG. 2. The ordinate axis of this graph represents the value in which the Q value of the dielectric resonator 10 is divided by Q₀ which is the Q value of the dielectric resonator using a normal electrode in place of the thin-film multilayer electrodes 11 and 12. It is understood that the energy loss decreases as Q/Q₀ increases, and in the case where Q/Q₀ is larger than 1, the energy loss is smaller than in the case where a normal electrode is used.

FIG. 2 shows the tendency that the energy loss decreases as the permittivity ∈ₐ of the interlayer dielectric material decreases. Simultaneously, only in the case where ∈ₐ/∈_{b} is smaller than approximately 0.5, the energy loss can be suppressed by using the thin-film multilayer electrode. Such conditions of permittivity are difficult to be satisfied by a cavity resonator or waveguide whose inside is a cavity. In other words, with such a cavity resonator and waveguide, it is difficult to suppress the energy loss in the same configuration as described in Patent Documents 1 and 2. With the dielectric resonators described in Patent Documents 1 and 2, the aforementioned conditions of permittivity can be satisfied by using an interlayer dielectric material having a low permittivity than that of the dielectric material in the resonant space. However, in that case, the combination of the dielectric material in the resonant space and the interlayer dielectric material is restricted.

In the meantime, if the energy loss of an electromagnetic wave is increased in a resonator or waveguide, they can be used as a filter for cutting the electromagnetic wave having the resonator's resonant frequency or the waveguide's propagation frequency.

The problem to be solved by the present invention is to provide a waveguide and resonator capable of controlling the amount of the energy loss due to the skin effect.

### Means for Solving the Problems

To solve the aforementioned problem, the present invention provides a waveguide including:

a spacer layer made of a cavity or dielectric material placed on a surface on a side of a propagation space of the waveguide; and

a layer made of a conductive material placed on a surface of the spacer layer,

wherein, with respect to a direction of a surface current in the electric conductor, the spacer layer is thicker at both ends than at a center thereof.

The present invention also provides a resonator including:

a spacer layer made of a cavity or dielectric material placed on a surface on a side of a resonant space of the resonator; and

a layer made of a conductive material placed on a surface of the spacer layer,

wherein, with respect to a direction of a surface current in the electric conductor, the spacer layer is thicker at both ends than at a center thereof.

The waveguide's propagation space and the resonator's resonant space may be a cavity (i.e. a cavity resonator) or may be filled with a dielectric material (i.e. a dielectric resonator). However, in the configuration described in Patent Documents 1 and 2, the effect of the present invention is more prominent in a cavity resonator, in which controlling the energy loss is difficult.

The waveguide and the resonator may be composed of an outside tube and inside tube which are coaxially disposed. In this case, the space between the outside tube and the inside tube corresponds to the propagation space or resonant space, and the inner surface of the outside tube or the outer surface of the inside tube corresponds to the surface on the side of the propagation space or the surface on the side of the propagation space. In this instance, the conductive material layer and the spacer layer may preferably be placed both on the outer surface of the inside tube and on the inner surface of the outside tube.

### EFFECTS OF THE INVENTION

In the waveguide and resonator according to the present invention, the spacer layer is thicker at both ends than at a center thereof. Hence, the resonant frequency of the equivalent circuit which is composed of the inner surface of a waveguide or resonator, conductive material layer, and spacer layer becomes higher than in the case where the spacer layer has a uniform thickness. This brings about the same effect as decreasing the spacer layer's permittivity. Therefore, it is possible to suppress the energy loss due to the skin effect more easily than before. In particular, the present invention makes this effect possible also in a waveguide whose propagation space is a cavity and a resonator whose resonant space is a cavity, in which suppressing the energy loss has been conventionally difficult.

In addition, the electromagnetic wave's energy loss can be increased depending on the thickness and area of the conductive material layer and spacer layer. In this case, the resonator and waveguide according to the present invention can be used as a filter for cutting the electromagnetic wave having the resonant frequency or the waveguide's propagation frequency.

### BRIEF DESCRIPTION OF THE DRAWINGS

FIG. 1(a) is a longitudinal section view illustrating an example of a conventional dielectric resonator, and FIG. 1(b) a top view illustrating an example of a thin-film multilayer electrode.

FIG. 2 is a graph illustrating the computational result of the Q value of a resonator having a thin-film multilayer electrode.

FIG. 3 is a longitudinal section view illustrating an example of a conductive material layer and spacer layer in the present invention.

FIG. 4 is a diagram illustrating the oscillation directions of the electric field and the magnetic field of an electromagnetic wave formed inside a spacer layer 24, and FIG. 4(b) illustrates an equivalent circuit composed of a wall 22, conductive material layer 23, and spacer layer 24.

FIG. 5 is an external view of a coaxial resonator 30 according to an embodiment of the present invention.

FIG. 6 is an axial sectional view of the coaxial resonator 30.

FIG. 7 is a diagram illustrating the computational results of the frequency of the electromagnetic wave inside the spacer layer 36.

FIG. 8 is a graph illustrating the computational result of the frequency of the electromagnetic wave inside the spacer layer 36.

FIG. 9(a) is a longitudinal section view illustrating the measurement conditions of the Q value in the coaxial resonator of the present embodiment, and FIG. 9(b) is a graph illustrating the measurement result of the Q value, computational result of the Q value, and measurement result of the frequency in the same coaxial resonator.

FIG. 10 is an axial sectional view illustrating a modification example of the coaxial resonator 30.

FIG. 11 is a longitudinal section view of a dielectric resonator 40 according to an embodiment of the present invention.

FIG. 12 is a section view of a circular waveguide 50 according to an embodiment of the present invention.

### EXPLANATION OF NUMERALS

10, 40 . . . Dielectric Resonator
11, 12, 41, 42 . . . Thin-Film Multilayer Electrode
111, 113, 121, 123 . . . Conductive Material
112, 122 . . . Interlayer Dielectric
12 . . . Thin-Film Multilayer Electrode
13 . . . Resonator Dielectric
21 . . . Internal Space
22 . . . Wall Made of a Conductive Material
23, 35, 413, 423, 53 . . . Conductive Material Layer
23A, 35A, 44A . . . Center of the Conductive Material Layer
23B, 35B, 44B, 44C . . . End of the Conductive Material Layer
23C . . . Intermediate Point of the Conductive Material Layer
24, 36, 412, 422, 52 . . . Spacer Layer
26 . . . Capacitor
27 . . . Coil
30, 30A . . . Coaxial Resonator
31 . . . Outside Tube
31A . . . End Face of the Outside Tube and Inside Tube
32 . . . Inside Tube
33 . . . Central Axis
34 . . . Cross Section Perpendicular to the Central Axis 33
35AB . . . Distance Between the Center of the Conductive Material Layer 35A and the End 35B
35C . . . Step of the Conductive Material Layer
351 . . . Outside Conductive Material Layer
361 . . . Outside Spacer Layer
36A . . . Polyimide Film
36B . . . Polyethylene Mesh
37 . . . Cavity
50 . . . Circular Waveguide

### BEST MODE FOR CARRYING OUT THE INVENTION

In the waveguide and resonator according to the present invention, as illustrated in FIG. 3, a conductive material layer 23 made of a conductive material is provided in the vicinity of a wall 22, with a space 24 in between. The wall 22 is made of a conductive material and surrounds an internal space 21 which is a propagation space for allowing an electromagnetic wave to pass through in the waveguide or a resonant space for oscillating an electromagnetic wave in the oscillator. The wall 22 may be made of the same material as used in a conventional waveguide and oscillator. The space 24 between the wall 22 and the conductive material layer 23 is the spacer layer in the present patent application. Regarding the thickness of the spacer layer 24, an end 23B is made to be thicker than a center 23A in which the current value becomes largest, with respect to the direction of the surface current passing through the conductive material layer 23 when an electromagnetic wave is existent in the internal space 21.

The spacer layer 24 may preferably be made of a material having a permittivity as low as possible in order to heighten the present invention's effect. One of such materials is typically a vacuum. Alternatively, a dielectric material may be filled in the space 24 in order to simplify the manufacture of the apparatus. Although the dielectric material may be any gas, liquid, and solid, a material having a permittivity similar to a vacuum, such as expanded polyethylene, may preferably be used. Alternatively, a porous or mesh dielectric material may be used for the spacer layer so that the effective permittivity can be further decreased.

In order to form the spacer layer 24 to have the aforementioned configuration, the conductive material layer 23 is transformed from the flat state in such a manner that the end 233 is more distanced from the wall 22 than the center. Such a configuration may typically has a step formed at the intermediate point 23C between the center 23A and end 23B as illustrated in FIG. 3. In addition, other configurations may be adopted such as: forming a step at a different position from the intermediate point 23C, or, in place of providing a step, forming the conductive material layer 23 in such a manner that its distance from the wall 22 gradually increases from the center 23A toward the end 23B.

In the example of FIG. 3, the conductive material layer 23 and the spacer layer are each provided in only a single layer. However, a plurality of these layers may be alternately laminated.

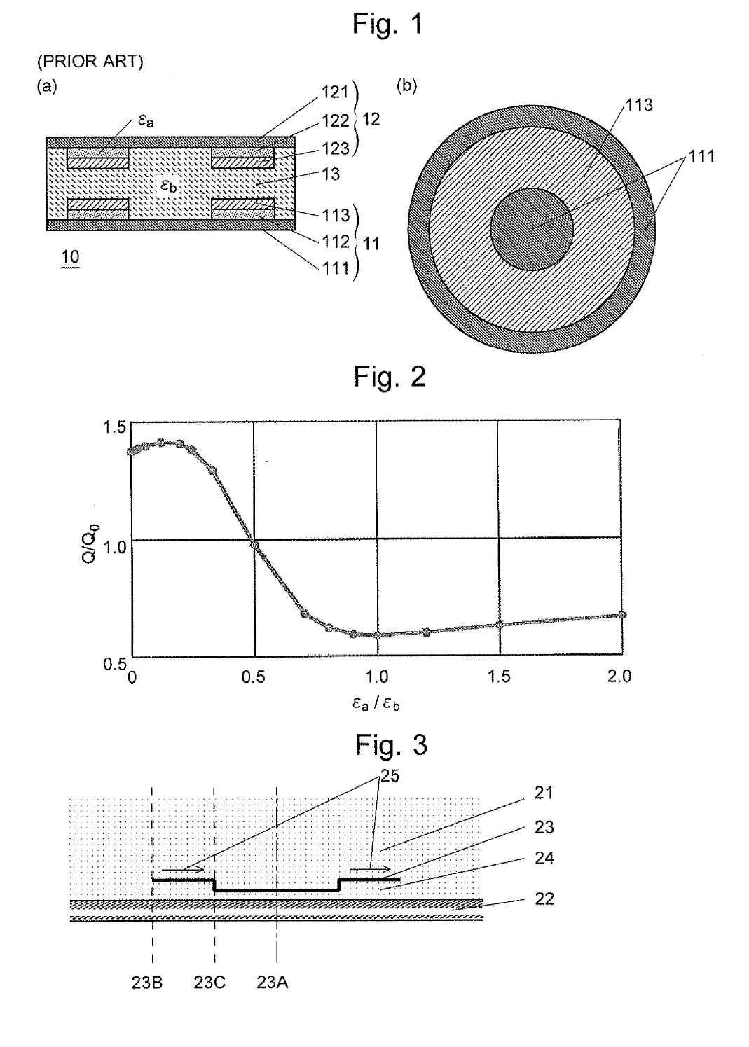

The provision of the conductive material layer 23 and the spacer layer 24 suppresses the energy loss due to the skin effect as in the conventional resonator illustrated in FIGS. 1 and 2. Then, the effect becomes more prominent than before since the conductive material layer 23 and the spacer layer 24 are configured as previously described. The reason will be described below.

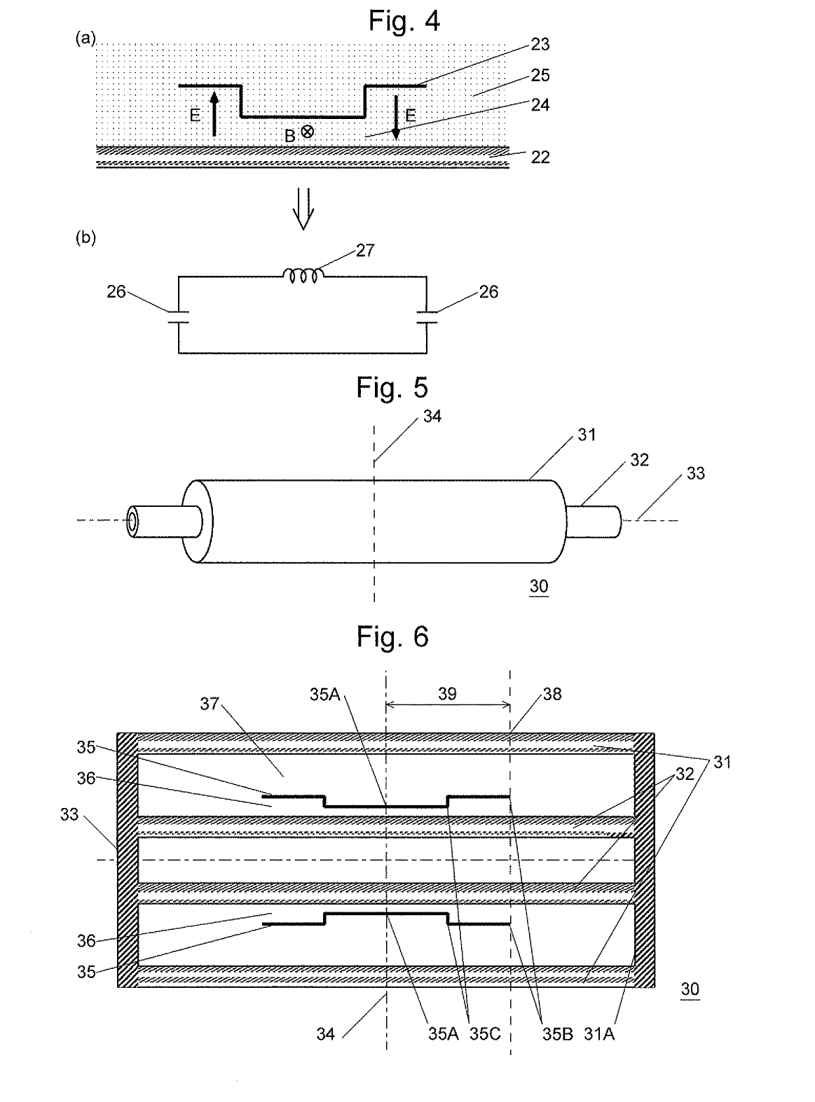

In the case where an electromagnetic wave is existent in the internal space 21 and the width of the spacer layer 24 is approximately half of the electromagnetic wave, an electromagnetic field is formed in the spacer layer 24 independently from the electromagnetic field in the internal space 21 (FIG. 4(a)). The intensity of the electric field in the direction perpendicular to the inner surface of the wall 22 and the conductive material layer 23 becomes largest in the vicinity of the end 23B, and the intensity of the magnetic field becomes largest in the vicinity of the center 23A. Due to the formation of such an electromagnetic field, the electromagnetic field in the spacer layer 24 can be expressed with the equivalent circuit illustrated in FIG. 4(b). This equivalent circuit represents the configuration of the wall 22, conductive material layer 23, and spacer layer 24, in which the vicinity of the end 23B corresponds to the capacitor 26 and the vicinity of the center 23A corresponds to the coil 27. Decreasing the thickness of the spacer layer 24 in the vicinity of the center 23A and increasing it in the vicinity of the end 23B correspond to decreasing both the capacitance C of the capacitor 26 and the inductance L of the coil 27 in the equivalent circuit of FIG. 4(b). Since the equivalent circuit's resonant frequency is proportional to C^{-1/2} and L^{-1/2}, reducing the capacitance C and inductance L in such a manner increases the resonant frequency of the equivalent circuit. The increase of the resonant frequency is equivalent to the reduction of the permittivity of the spacer layer 24.

Since the permittivity of the spacer layer 24 equivalently decreases as just described, the energy loss due to the skin effect can be suppressed as illustrated in FIG. 2. Therefore, by configuring the conductive material layer 23 and the spacer layer 24 as previously described in the present invention, the energy loss can be reduced more than before.

For the component of the electric field in the direction perpendicular to the conductive material layer 23 and that of the magnetic field parallel to the conductive material layer 23, the magnetic field is stronger on the side of the center 23A and the electric field is stronger on the side of the end 23B around the intermediate point 23C as a boundary. Therefore, the conductive material layer 23 may preferably have a step at the intermediate point 23C.

### EMBODIMENTS

### (1) Embodiment of a Coaxial Resonator

An example of the coaxial resonator which is an embodiment of the present invention will be described with reference to FIGS. 5 and 6. FIG. 5 is an external view of the coaxial resonator 30 of the present embodiment, and FIG. 6 is an axial sectional view of the coaxial resonator 30. In the axial sectional view of FIG. 6, the longitudinal direction of the cross section is enlarged for convenience of explanation. An outside tube 31 and an inside tube 32 are a tube made of a conductive material and having a radius different from each other. They are coaxially arranged to share a central axis 33. The region between the outside tube 31 and the inside tube 32 is a cavity 37 for oscillating the electromagnetic wave in the transverse electromagnetic (TEM) mode, and the outside tube 31 and the inside tube 32 form the wall of the cavity 37.

In the vicinity of the outer surface of the inside tube 32, a conductive material layer 35 is placed in such a manner as to surround the inside tube 32. The conductive material layer 35 has a symmetric shape with respect to the cross section 34 perpendicular to the central axis 33, which is equally distant from both end faces of the outside tube 31. The end 35B of the conductive material layer 35 is equally distant from the end face 31A of the outside tube 31 and inside tube 32, and the cross section 34. At the midpoint between the center 35A and the end 35B of the conductive material layer 35, a step 35C is provided so that the conductive material layer 35 is closer to the inside tube 32 on the side of the center 35A than on the side of the end 35B. The space between the inside tube 32 and the conductive material layer 35 is a cavity: this portion is a spacer layer 36.

In order to increase the resonant frequency in the spacer layer 36, the spacer layer 36 may preferably be a cavity: however, the spacer layer 36 may be filled with a dielectric material. In this case, the conductive material layer 35 and the spacer layer 36 can be easily manufactured in the following manner: the spacer layer 36 having a step is first formed on the surface of the inside tube 32 by a dielectric material which serves as an adhesive, and then a conductive material layer 35 is formed (or attached) thereon.

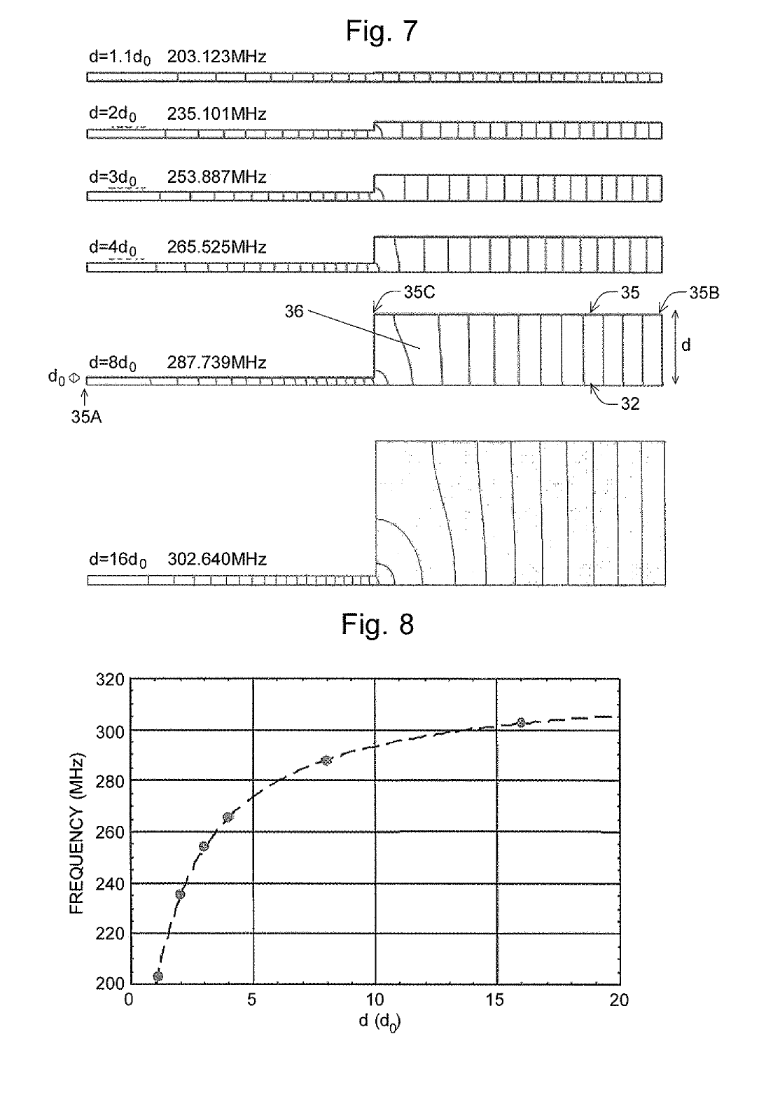

The computational result of the frequency of the electromagnetic wave in the spacer layer 36 in the coaxial resonator 30 of the preset embodiment will be described with reference to FIGS. 7 and 8. In this computation, the distance between the center 35A and the end 35B in the conductive material layer 35 was set to be 250 mm, and the distance between the center 35A and the step 35C and the distance between the step 35C and the end 35B were both set to be 125 mm. The thickness d₀ of the spacer layer 36 between the center 35A and the step 35C was fixed to be 4 mm, and the resonant frequency of the electromagnetic wave in the spacer layer 36 was computed while changing the thickness d of the spacer layer 36 between the step 35C and the end 35B to be 1.1d₀, 2d₀, 3d₀, 4d₀, 8d₀, and 16d₀.

FIG. 7 illustrates the computational result of the resonant frequency in the spacer layer 36 with respect to the thickness d. The vertical lines in the figure signify the electric flux line in the direction perpendicular to the surface of the inside tube 32, and a narrower interval between the lines signifies a stronger electric field in this direction. FIG. 8 illustrates the computational result in a graph. As a comparative example, a computation was performed for the case where a conductive material layer without the step 35C was provided as in the case of the resonator described in Patent Document 2: the resonant frequency between the conductive material layer and the inside tube was 198 MHz, which is smaller than any computational result in the present embodiment. That is, with the configuration of the present embodiment, the resonant frequency in the spacer layer 36 can be increased more than before. Therefore, the energy loss due to the skin effect can be suppressed. The greater d becomes, the higher the resonant frequency in the spacer layer 36 becomes, and accordingly the effect of the present invention becomes more prominent.

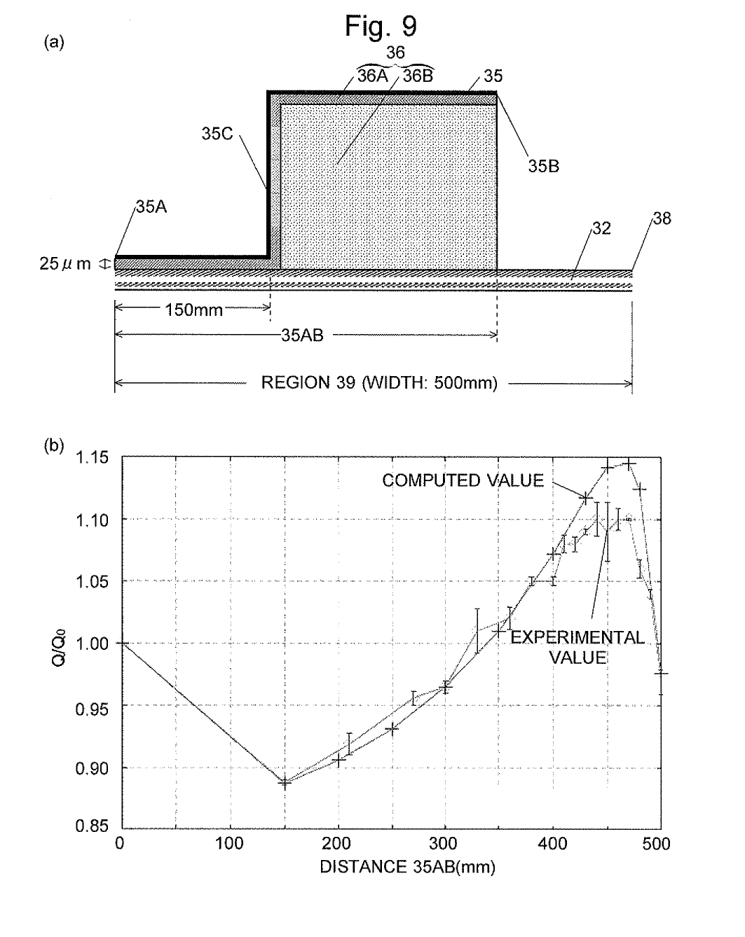

Next, the measurement result of the Q value and resonant frequency of the resonator in the coaxial resonator 30, and the computational result of the Q value using the conditions corresponding to the measurement conditions will be described with reference to FIG. 9. FIG. 9(a) is a magnified view of the inside tube 32, conductive material layer 35, and spacer layer 36 in a region 39 extending from the center 35A to an intermediate point 38 between the center 35A and the end 31A of the axial resonator 30 used in the measurement. The outside tube 31 (not shown) has an overall length of 2131.4 mm, the outside diameter of 55 mm, and the inside diameter of 50 mm. The inside tube 32 has an overall length of 2428.2 mm, the outside diameter of 40 mm (radius of 20 nm), and the inside diameter of 36 mm. The thickness of the conductive material layer 35 is 5 μm. Either of the inside tube 32, outside tube, and the conductive material layer 35 is made of copper. The spacer layer 36 is composed of a polyimide film 36A with the thickness of 25 μm in the region between the center 35A and the step 35C, and is composed of the lamination of a polyimide film 36A with the thickness of 25 μm and a polyethylene mesh 36B with the thickness of 300 μm in the region between the step 35C and the end 3513 of the conductive material layer. The conductive material layer 35 and the spacer layer 36 were manufactured by coating the surface of the polyethylene mesh 36B with commercially available “Metaloyal” (product and registered trademark of Toyo Metalizing Co., Ltd.) in which a conductive material layer 35 is evaporated on the surface of a polyimide film 36A. In this embodiment, for convenience of measurement, the step 35C was fixed at the position 150 mm away from the center 35A, and the measurement was performed while changing the position of the end 35B of the conductive material layer from the center 35A, in the range between 150 mm (i.e. the position of the step 35C) and 500 mm (i.e. around the intermediate point 38).

The measurement result and the computational result are illustrated in FIG. 9(b). In this figure, the distance 35AB between the center 35A and the end 35B of the conductive material layer in the conductive material layer 35. The ordinate axis represents the value Q/Q₀ in which the Q value at each measurement point is divided by Q₀ which is the Q value without the conductive material 35 (in the case where the value of the abscissa axis is 0). The Q/Q₀ value is in agreement with the computed value. In addition, this result shows that in the case where the distance 35AB is approximately longer than 330 mm, Q/Q₀ is larger than 1, i.e. the loss can be suppressed. On the other hand, in the case where the distance 35AB is less than 330 mm, Q/Q₀ is smaller than 1, which allows the resonator to be used as a filter for suppressing an electromagnetic wave having the resonator's resonant frequency.

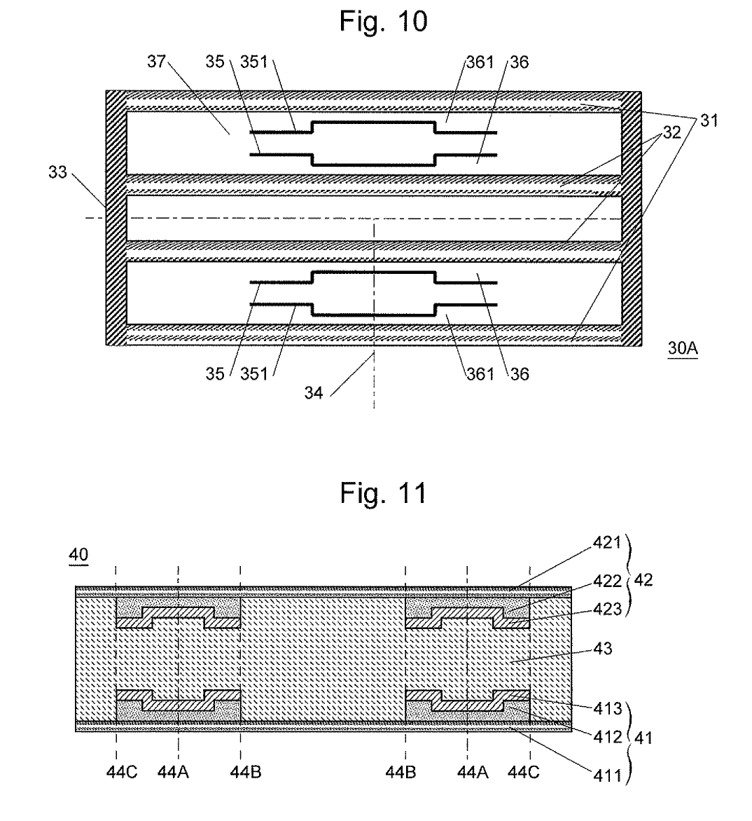

FIG. 10 illustrates a coaxial resonator 30A which is a modification example of the coaxial resonator 30. The coaxial resonator 30A has an outside tube 31, an inside tube 32, a conductive material layer 35, and a spacer layer 36 which are the same as in the coaxial resonator 30. In addition, the coaxial resonator 30A has an outside conductive material layer 351 and an outside spacer layer 361 on the inner surface of the outside tube 31. The outside conductive material layer 351 and the outside spacer layer 361 are line symmetrical to the conductive material layer 35 and the spacer layer 36 in the cross section including the axis. Due to the provision of such an outside conductive material layer 351 and outside spacer layer 361, the coaxial resonator 30A can further suppress the power loss than the coaxial resonator 30.

### (2) Embodiment of a Dielectric Resonator

A dielectric resonator 40 which is another embodiment of the present invention will be described with reference to FIG. 11. This dielectric resonator 40 is composed of, as in the conventional dielectric resonator 10 illustrated in FIG. 1, a cylindrical resonator dielectric 43 and thin-film multilayer electrodes 41 and 42 provided at the opposite sides of the resonator dielectric 43, respectively. In addition, as in the dielectric resonator 10, the thin-film multilayer electrode 41 (42) is composed of the following three components: a disk-shaped electric conductor 411 (421), a doughnut-shaped spacer layer 412 (422) having a central hole and placed on the electric conductor 411, and a conductive material layer 413 (423) placed on the spacer layer 412. The spacer layer 412 has the smaller outside diameter than that of the electric conductor 411, and the shape of the conductive material layer 413 is the same as the spacer layer 412. In the present embodiment, the spacer layer 412 (422) is configured in such a manner that, in the longitudinal section passing through the center of the doughnut illustrated in FIG. 1, the center 44A is thinner than the end face 44B and the end face 44C of the inside diameter of the doughnut. With such a configuration of the spacer layer 412 (422), the energy loss due to the skin effect can be suppressed as in the aforementioned coaxial resonator.

### (3) Embodiment of a Waveguide

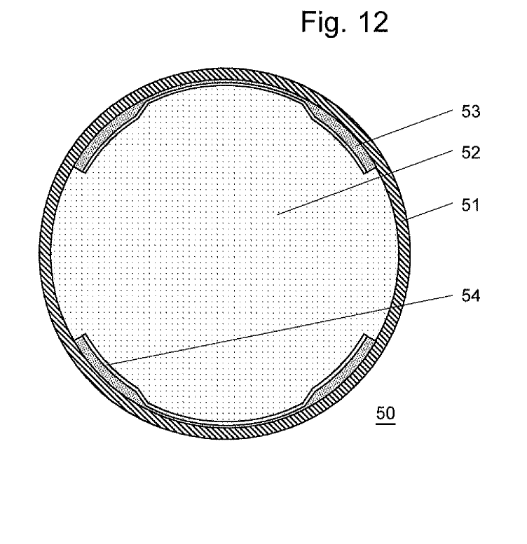

A circular waveguide 50 which is another embodiment of the present invention will be described with reference to FIG. 12. FIG. 12 illustrates a cross section perpendicular to the axis of the circular waveguide. This circular waveguide 50 is a TE₁₁ mode waveguide, in which an electromagnetic wave is allowed to propagate in the axial direction in a space 52 in a circular tube 51 made of a conductive material. A spacer layer 53 covering a portion of the inner surface of the circular tube 51 is provided, and a conductive material layer 54 is provided on the surface of the spacer layer 53. The spacer layer 53 is formed in such a manner that the ends are thicker than the center. Two pairs of the spacer layer 53 and the conductive material layer 54 are provided in opposition to each other. With such a configuration of the spacer layer 53, the energy loss due to the skin effect can be suppressed.

1. A waveguide comprising:
a spacer layer made of a cavity or dielectric placed on a surface on a side of a propagation space of the waveguide; and
a conductive layer made of a conductive material placed on a surface of the spacer layer,
wherein, with respect to a direction of a surface current in the electric conductor, the spacer layer is ticker at both ends than at a center thereof.

2. The waveguide according to claim 1, wherein the propagation space is a cavity.

3. The waveguide according to claim 1, wherein a plurality of the conductive material layers and the spacer layers are alternately laminated.

4. The waveguide according to claim 1, wherein the propagation space is a space between an outside tube and an inside tube which are coaxially disposed, and the conductive material layer and the spacer layer are placed both on an outer surface of the inside tube and on an inner surface of the outside tube.

5. A resonator comprising:
a spacer layer made of a cavity or dielectric placed on a surface on a side of a resonant space of the resonator; and
a conductive layer made of a conductive material placed on a surface of the spacer layer,
wherein, with respect to a direction of a surface current in the electric conductor, the spacer layer is thicker at both ends than at a center thereof.

6. The resonator according to claim 5, wherein the resonant space is a cavity.

7. The resonator according to claim 5, wherein a plurality of the conductive material layers and the spacer layers are alternately laminated.

8. The resonator according to claim 5, wherein the resonant space is a space between an outside tube and an inside tube which are coaxially disposed, and the conductive material layer and the spacer layer are placed both on an outer surface of the inside tube and on an inner surface of the outside tube.

9. The waveguide according to claim 1, wherein a step is provided at an intermediate point between the center and the end so that the spacer layer is thicker at both ends than at the center thereof.

10. The resonator according to claim 5, wherein a step is provided at an intermediate point between the center and the end so that the spacer layer is thicker at both ends thereof than at the center.

11. The resonator according to claim 5, wherein the resonator is a coaxial resonator.

12. The resonator according to claim 5, wherein the resonator is a dielectric resonator.

13. The waveguide according to claim 1, wherein the waveguide is a circular waveguide.
